(19) United States
(12) Patent Application Publication
(10) Pub. No.: US 2017/0308526 A1
(43) Pub. Date: Oct. 26, 2017

(54) Compcuter Implemented machine translation apparatus and machine translation method

(71) Applicant: National Institute of Information and Communications Technology, Tokyo (JP)

(72) Inventor: Masao UCHIYAMA, Tokyo (JP)

(21) Appl. No.: 15/490,263

(22) Filed: Apr. 18, 2017

(30) Foreign Application Priority Data
Apr. 21, 2016 (JP) 2016-085262
Apr. 7, 2017 (JP) 2017-077021

(51) Int. Cl. G06F 17/28; G06F 17/27; G06F 17/21

(52) U.S. Cl. CPC G06F 17/2818; G06F 17/218; G06F 17/271

(57) ABSTRACT

A machine translation apparatus 230 capable of appropriately translating source sentences differently in accordance with information exceeding the scope of source sentences includes: a grammatical type determining unit 282 for identifying grammatical type of a source sentence; a grammatical-type-based tagging unit 286 for adding first and second tags corresponding to the grammatical type to head and tail positions of the source sentence, respectively; and a phrase-based statistical machine translation apparatus 288 configured to receive the source sentence having the first and second tags added. Different types are defined as grammatical types. The grammatical type determining unit 282 selects the first and second tags in accordance with the different grammatical types.

### CROSS-REFERENCE TO RELATED APPLICATION

The present application claims priority under 35 U.S.C. §119 to Japanese Patent Application Nos. 2016-085262 and 2017-077021, filed Apr. 21, 2016 and Apr. 7, 2017, respectively, the contents of which are incorporated herein by reference in their entirety.

### BACKGROUND OF THE INVENTION

### Field of the Invention

The present invention relates to a machine translation apparatus and, more specifically, to a method and an apparatus for machine translation capable of highly accurate translation by appropriately reflecting differences in source sentences to translated sentences.

### Description of the Background Art

Among various types of statistical machine translations, Phrase based Statistical Machine Translation (PBSMT) is considered to be promising. In PBSMT, source sentences are divided into chains of a few words referred to as phrases. Each chain is translated to a phrase of the counterpart language, and then, the translated phrases are reordered (see Taro Watanabe, Kenji Imamura, Hideto Kazawa, Graham Neubig, Toshiaki Nakazawa, KIKAIHON'YAKU (Machine Translation), (Shizen Gengo Shori series 4 (Natural Language Processing series 4)), Corona-publishing Co. Ltd., ISBN:978-4-339-02754-9, the entire contents of which are incorporated herein by reference. This reference will be hereinafter referred to as Watanabe et al.). The term “phrase” here is different from those in linguistics, and here it simply refers to a chain of words. Phrase-by-phrase translation can automatically be learned from translation pair data. For example, in English-to-Japanese translation, “Hello !” can automatically be processed as corresponding to “ [symbol] (kon'nichiwa)(usual daytime greeting)” or “ [symbol] (moshi-moshi) (greeting to start conversation on telephone).” In the following, description will be given assuming that the source sentences are in Japanese and the translated sentences are in English, while the forgoing similarly applies to other languages.

PBSMT is fast and capable of highly accurate translation particularly between languages having similar structures. Further, recent developments include preliminary reordering where phrases in source sentences are reordered to be closer to the word order of counterpart language before applying PBSMT. This approach has enabled highly accurate translation between languages having much different word orders such as English and Japanese, or Chinese and Japanese. This technique of translation after changing the word order is referred to as “pre-reordering.” The method of pre-reordering is described in Japanese Patent Application publication JP2013-250605.

In PBSMT learning, a phrase table is prepared. The phrase table contains many phrase pairs. A phrase pair is a combination of phrases in two languages forming mutual translations.

Learning of a phrase table uses a bilingual corpus including many translation pairs. A translation pair is, for example, a pair 30 of sentences shown in FIG. 1, that is, a combination of sentences in two languages each being a translation of the other. Main part of PBSMT learning is to extract correspondence between phrases, each consisting of a word sequence forming each pair, and to form phrase pairs.

In PBSMT training, it is known that the accuracy of translation is improved by inserting symbols representing a sentence head or a sentence tail in each of the source and translation sentences of each translation pair in the bilingual corpus during training and by inserting the same symbols in the source sentences at the time of actual translation. By way of example, referring to FIG. 1, tags <s> 40 and 44 representing the head of a sentence are added to both of the head of source sentence and the head of translated sentence of the translation pair 32, and tags </s> 42 and 46 representing the tail of a sentence are added to the tails of these sentences. By using translation pairs having tags <s> and </s> thus added to the head and tail of each sentence at the time of training and by adding similar tags to the source sentences at the time of actual translation, performance of PBSMT can be improved for the following reasons.

In PBSMT training, each of the tags added to the head and tail of a sentence is processed like a word. As a result, alignment between phrases becomes more precise. In the example mentioned above, when “ [symbol] (kore)” appears at the head of a sentence in the source sentence (Japanese), “<s> [symbol] (kore)” is aligned with “<s> This” in the translated sentence (English). When “ [symbol] (kore)” appears in the middle of the source sentence (not at the head), it is aligned with “this” in the translated sentence. Specifically, phrases forming a pair in the source sentence and the translated sentence (phrase pair) may appear in different positions in the translation pairs and even in such a case, difference in the positions can be distinguished and processed appropriately. In other words, adding tags as auxiliary information indicating word positions leads to precise alignment of phrases.

### SUMMARY OF THE INVENTION

As described above, PBSMT enables fast and highly accurate machine translation. PBSMT, however, still has room for improvement. One of the problems of PBSMT is that it is difficult to introduce information stretching beyond the scope of a phrase to translation, even when tags indicating head and tail of sentences are appended. The problems will be specifically discussed in the following.

(1) It is difficult to translate differently in accordance with grammatical types of source sentences

Conventional PBSMT has a problem that when grammatical types of source sentences are different, it is difficult to appropriately reflect the difference to the translation. The possible reasons are as follows.

Consider Japanese to English translation of a noun phrase 60, “ [symbol] [symbol] (kansa no kekka),” as indicated on the upper part of FIG. 2. In PBSMT, this source sentence is first subjected to word reordering 62, and as a result, a word sequence 64, “ [symbol] (kekka no kansa),” is obtained. This word sequence 64 is subjected to tagging process 66, by which a start tag <s> is added to the head and an end tag </s> is added to the tail. As a result, we obtain a word sequence 68. When this word sequence 68 is subjected to PBSMT translation 70, the resulting translation of noun phrase 60 will be an adverb phrase 72, “As a result of the audit.” Specifically, translation of a noun phrase 60 provides not a noun phrase but an adverb phrase 72.

Another similar example is shown on the lower part of FIG. 2. This is an example of translating an question sentence 80, “Web [symbol] [symbol] ? (Web server no service wa dousachu ka),” to English. The question sentence 80 is subjected to word reordering 82 and we obtain a word sequence 84, “ [symbol] Web [symbol] [symbol] ? (no Web server service wa dousachu ka)”. By tagging process 86 on this word sequence, we obtain a word sequence 88, “<s> [symbol] Web [symbol] [symbol] ?</s> (<s> no Web server service wa dousachu ka </s>)”. When this word sequence 88 is subjected to PBSMT translation 90, the resulting translation 92 will be “the web server service running?” This is not an interrogative or a declarative sentence.

Such a problem arises for the following reasons.

Consider Japanese to English translation in which tagged translation pair includes the following interrogative sentences.

<s> Web [symbol] [symbol] [symbol] ? </s>

(<s> Web server no service wa dousachu ka ?</s>)

<s> Is the Web server service running ? </s>

On the other hand, the following declarative sentences may also be used as translation pair used for training.

<s> [symbol] [symbol] [symbol] </s>

(s> Web server no service wa dousachu desu </s>)

<s> The Web server service is running. </s>

Descriptions of these two sentences are not much different.

After word re-ordering, these pairs will be as follows.

<s> [symbol] Web [symbol] [symbol] [symbol] ? </s>

(<s> no Web server service wa dousachu ka ?</s>)

<s> Is the Web server service running ?</s>

(<s> no Web server service wa dousachu desu </s>)

<s> [symbol] Web [symbol] [symbol] [symbol] </s>

<s> The Web server service is running. </s>

Descriptions of these two sentences are not much different. When such data of translation pairs are used, appropriate training of a phrase table is impossible. Specifically, the identical Japanese phrase “<s> [symbol] Web [symbol] (<s> no Web server)” corresponds to “The Web server service is” in one sentence and to “<s> Is the Web server service” in another of the two translation pairs above. Therefore, within the scope of this phrase, it is impossible to determine which of the translations should be selected as the translation of “<s> [symbol] Web [symbol] (<s> no Web server)”. As a result, the declarative sentence, which appears more frequently, is always used, and translation of the interrogative sentence fails.

A solution to this problem is proposed in Andrew Finch, Eiichiro Sumita, Dynamic Model Interpolation for Statistical Machine Translation, Proceedings of the Third Workshop on Statistical Machine Translation, pages 208-215, 2008, the entire contents of which are incorporated herein by reference. In the following, this reference will be referred to as “Finch et al.” Finch et al. proposes, as models used by PBSMT, models obtained by linearly interpolating models generated from translation pairs of interrogative sentences and models generated from translation pairs of sentences other than interrogatives.

Another possible solution is to separately configure a translation engine for interrogative sentences and a translation engine for noun phrases, in order to translate interrogative sentences as interrogatives and noun phrases as noun phrases. FIG. 3 shows a typical example of a translation apparatus of this scheme.

Referring to FIG. 3, a bilingual corpus 110 is prepared. A model training unit 114 trains models 112 for translation of different grammatical types, using this bilingual corpus 110. Model training unit 114 divides translation pairs in this bilingual corpus to partial corpora 130 in accordance with their grammatical types (interrogative, declarative, noun phrase and so on). Model training unit 114 further performs training 132 of PBSMT by the same conventional method using partial corpora 130, and builds models 112 for translation. Each of models 112 includes a phrase table and has a configuration suitably adapted for translation of a specific grammatical type. By incorporating these models in separate machine translation apparatuses, translation engines suitable for respective grammatical types can be realized. For example, by incorporating a model for noun phrases in a machine translation apparatus 120, machine translation apparatus 120 becomes a translation engine dedicated to translation of noun phrases.

At the time of translation, in accordance with the grammatical type of an input sentence 118, an appropriate translation engine is used from among the translation engines for different grammatical types. By way of example, machine translation apparatus 120 for noun phrase includes: a morphological analysis unit 140 for morphologically analyzing input sentence 118; a syntactic analysis unit 142 for syntactically analyzing a morpheme sequence output from morphological analysis unit 140, in preparation for pre-reordering of the source sentence; a pre-reordering unit 144 using the result of syntactic analysis by syntactic analysis unit 142 for reordering words in input sentence 118 into an order close to that of English; a tagging unit 146 for adding a start tag <s> and an end tag </s> to the head and tail of reordered input sentence 118; and a PBSMT apparatus 148 for performing PBSMT on the tagged input sentence 118 and outputting a translated sentence 122.

FIG. 4 shows, in the form of a flowchart, a control structure of a computer program realizing the tagging unit 146 shown in FIG. 3. Referring to FIG. 4, this program is called from a parent routine using an input sentence (word sequence) as an argument. This program includes a step 160 of declaring a variable STR for storing a character sequence, and a step 162 of concatenating a start tag <s>, the input sentence (word sequence) and an end tag </s> in this order and storing the result in variable STR and returning control to the main routine using the variable STR as a return value.

By using such a method, a translation engine for noun phrase, for example, can be configured. For training, bilingual corpus consisting only of titles of patent documents or scientific articles may be used, and whereby a translation engine dedicated to titles can be formed.

When this method is used, however, it becomes necessary to build translation engines by dividing bilingual corpus 110 in accordance with types of interrogative sentences. As a result, the amount of translation pair data used in training of translation engines becomes smaller. It has been known that the amount of translation pair data used for training has significant influence on the accuracy of translation engine. Thus, the translation engines built separately for different grammatical types will have lower translation performances. Further, operational cost increases because a plurality of translation engines are used.

In addition to the problem of the conventional technique that it is difficult to translate differently in accordance with the grammatical types, it is also difficult to translate differently in different situations. For example, correct translation of “Hello” in English to Japanese is “ [symbol] [symbol] (kon'nichiwa)(usual daytime greeting)” if it is in face-to-face conversation. If it is over telephone, however, it should be translated to “ [symbol] (moshi-moshi).” The conventional PBSMT is incapable of such differentiation unless the scheme shown in FIG. 3 is adopted.

Further, the conventional technique also has a problem that it is difficult to translate differently for different speakers. By way of example, in medical translation, it is sometimes necessary to translate one same sentence differently depending on whether the speaker is a patient or a nurse. For example, when “ [symbol] (kusuri wo nomimasu)” is to be translated to English, if the speaker is a patient, the subject must be “I” and if the speaker is a nurse, the subject must be “You.” The conventional PBSMT is incapable of such different translation in accordance with the speaker unless the scheme shown in FIG. 3 is adopted.

Further, the conventional technique also has a problem that it is difficult to translate differently for different contexts. Consider, for example, translating Japanese word “ [symbol] (hai)” to English. In a context of simple question such as “ [symbol] [symbol] [symbol] (anata wa ringo ga suki desuka)?” (Do you like an apple?), the Japanese answer “ [symbol] (hai)” can be translated to “Yes.” On the contrary, in a negative question context such as “ [symbol] [symbol] [symbol] [symbol] (anata wa ringo ga sukijanai desuka)?” (Don't you like an apple?), “ [symbol] (hai)” must be translated to “No.” The conventional PBSMT is incapable of such different translation depending on the contexts. Adoption of the scheme shown in FIG. 3 in this aspect is almost impossible, since there are numerous different contexts.

The above-described difficulties in translating differently depending on grammatical types, situations, speakers and contexts ultimately means that information stretching beyond the source sentence necessary for highly accurate translation is insufficient. Though it may be possible to supply such information to the machine translation apparatus, complicated processing for this purpose will lead to higher cost of translation, and is not desirable.

Further, the above-described problems are similarly experienced when translation systems other than PBSMT are used. For example, machine translation using LSTM (Long Short-Term Memory) have the same problems. For machine translation using LSTM, see Sutskever, I., Vinyals, O., and V. Le, Q., Sequence to sequence learning with neural networks. In Advances in Neural Information Processing Systems (2014), pp. 3104-3112. The contents of this article in its entirety are incorporated herein by reference. Hereinafter this reference will be referred to as “Sutskever et al.”

Therefore, a machine translation apparatus capable of precisely translating source sentences in accordance with information stretching beyond the scope of source sentences is strongly desired.

### Means to Solve the Problems

According to a first aspect, the present invention provides a machine translation apparatus implemented by a computer including a storage device and a central processing unit, wherein the central processing unit is programmed to or configured to specify a meta information item related to translation by a program stored in the storage device, and to insert a tag corresponding to the meta information item to a prescribed position of a source sentence of translation, and in response to an input of the source sentence with the tag, further to execute machine translation; a predetermined plurality of types of items are defined as the meta information item; and the central processing unit is programmed to or configured to select a tag in accordance with the type of the meta information item.

Preferably, the central processing unit is programmed to or configured to insert first and second tags corresponding to the meta information item to head and tail positions, respectively, of a scope of the source sentence to be translated using the meta information item to identify the scope when a tag related to the meta information item is to be inserted to the source sentence. More preferably, the central processing unit is programmed to or configured to perform morphological analysis of the source sentence, to perform syntactic analysis of the morphologically-analyzed source sentence, and to output information indicating grammatical type of the source sentence obtained as a result of syntactic analysis of the source sentence, as the meta information item of the source sentence when the meta information item is to be identified. Further preferably, a meta information item is added to a source sentence, the meta information item being related to translation of the source sentence; and the central processing unit is programmed to or configured to separate the meta information item added to the source sentence from the source sentence when the meta information item is to be identified.

Preferably, the meta information item is selected from the group consisting of grammatical type of the source sentence, situation information related to a situation where the source sentence is uttered, speaker information related to a speaker who utters the source sentence, and a grammatical type of preceding source sentence that has been subjected to the machine translation before the source sentence. More preferably, the central processing unit is programmed to or configured to perform phrase-based statistical machine translation when the machine translation is to be executed. Further preferably, the central processing unit is programmed to or configured to identify the target language of translation as the meta information item when the meta information item is to be identified, and when a tag corresponding to the meta information item is to be inserted to the source sentence, to insert a tag indicating the translation target language identified by the meta information item to a prescribed position of the source sentence.

Preferably, the central processing unit is programmed to or configured to perform neural-network-based machine translation when the machine translation is to be executed.

According to a second aspect, the present invention provides a machine translation method implemented by a computer including a storage device and a central processing unit, including the steps of: identifying a meta information item related to translation; inserting a tag corresponding to the meta information item to a prescribed position of a source sentence of translation; and receiving the source sentence with the tag as an input and executing machine translation; wherein a predetermined plurality of types of items are defined as the meta information items; and the step of identifying the meta information item includes the step of selecting the tag in accordance with the type of the meta information item.

Preferably, the step of inserting a tag corresponding to the meta information item into the source sentence includes the step of inserting first and second tags corresponding to the meta information item to head and tail positions, respectively, of a scope of the source sentence to be translated in order to identify the scope using the meta information item. More preferably, the step of identifying the meta information item includes the steps of morphologically analyzing the source sentence, syntactically analyzing the morphologically-analyzed source sentence, and outputting information indicating grammatical type of the source sentence obtained as a result of syntactic analysis of the source sentence, as the meta information item of the source sentence.

Further preferably, the source sentence has the meta information item related to translation of the source sentence added to the source sentence; and the step of identifying the meta information item includes the step of separating the meta information item added to the source sentence from the source sentence.

Preferably, the meta information item is selected from the group consisting of grammatical type of the source sentence, situation information related to a situation where the source sentence is uttered, speaker information related to a speaker who utters the source sentence, and a grammatical type of preceding source sentence subjected to the machine translation preceding the source sentence. More preferably, the step of executing machine translation includes the step of receiving the source sentence with the tag as an input and performing phrase-based statistical machine translation on the input. Further preferably, the step of identifying the meta information item includes the step of identifying the target language of translation as the meta information item, and the step of inserting a tag corresponding to the meta information item includes the step of inserting a tag indicating the translation target language identified by the meta information item to a prescribed position of the source sentence.

Preferably, the step of executing machine translation includes the step of performing neural-network-based machine translation.

According to a third aspect, the present invention provides a non-transitory storage medium having stored thereon a computer program causing a computer to execute each of the steps of any of the machine translation methods described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic illustration showing tagging in the conventional PBSMT.

FIG. 2 is a schematic illustration showing how an incorrect translation results in the conventional PBSMT.

FIG. 3 is a block diagram showing a method of building translation engines for different grammatical types by the conventional PBSMT.

FIG. 4 is a flowchart schematically representing a control structure of a program for adding start and end tags to head and tail of an input sentence, respectively, at the time of translation by conventional PBSMT.

FIG. 5 shows a process of translation by PBSMT in accordance with a first embodiment of the present invention.

FIG. 6 is a block diagram showing a functional structure of a PBSMT system in accordance with the first embodiment of the present invention and a training unit of the PBSMT system.

FIG. 7 is a flowchart schematically representing a control structure of a program for adding start and end tags to head and tail of an input sentence, respectively, at the time of translation by the PBSMT system in accordance with the first embodiment of the present invention.

FIG. 8 is a block diagram showing a functional structure of a PBSMT system in accordance with a second embodiment of the present invention and a training unit of the PBSMT system.

FIG. 9 is a block diagram showing a functional structure of a PBSMT system in accordance with a third embodiment of the present invention and a training unit of the PBSMT system.

FIG. 10 is a block diagram showing a functional structure of a translation system in accordance with a fourth embodiment of the present invention and a training unit of the translation system.

FIG. 11 is a flowchart representing a control structure of a program realizing the tagging unit of the training unit shown in FIG. 10.

FIG. 12 is a schematic diagram illustrating a process of Neural Network (NN) training by an NN training unit shown in FIG. 10.

FIG. 13 shows an appearance of a computer realizing the translation system in accordance with each of the embodiments of present invention and the training unit of the translation system.

FIG. 14 is a block diagram showing a hardware configuration of the computer of which appearance is shown in FIG. 13.

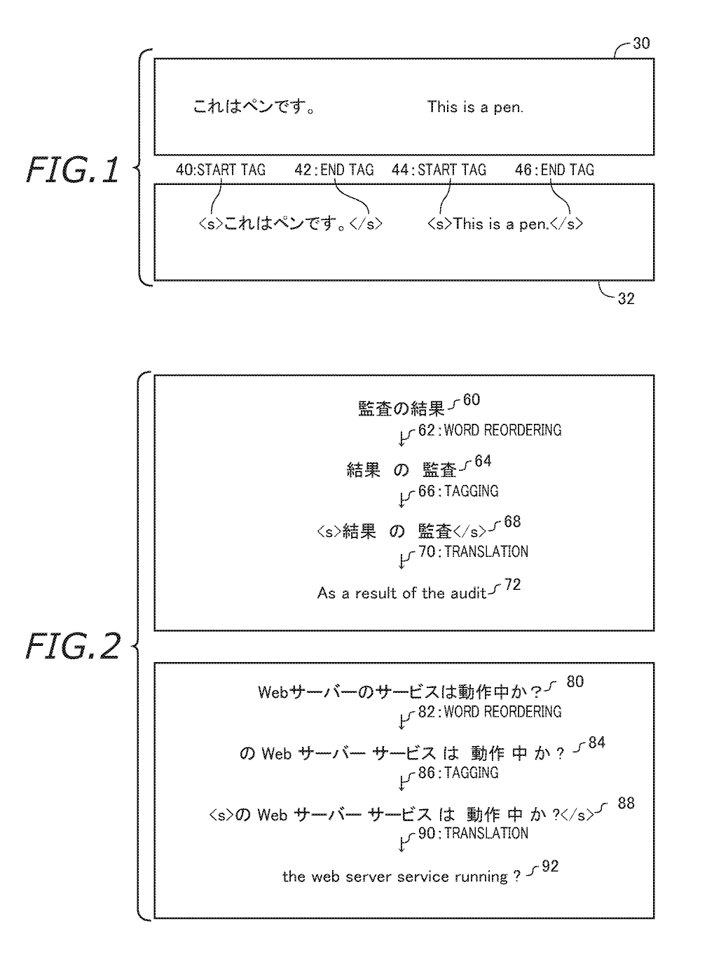

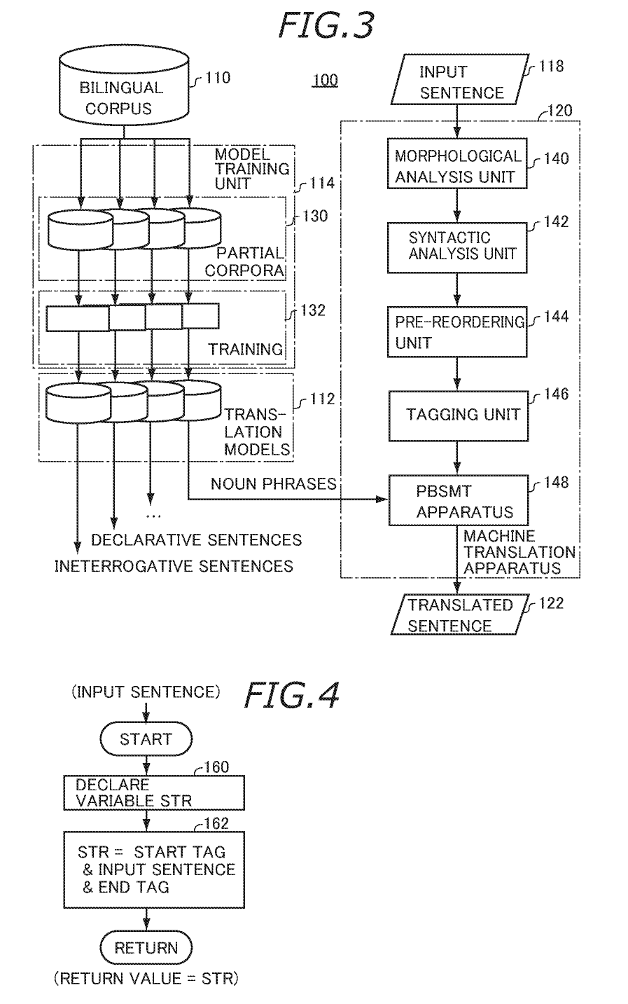

### DESCRIPTION OF THE PREFERRED EMBODIMENTS

In the following description and in the drawings, the same components are denoted by the same reference characters. Therefore, detailed description thereof will not be repeated.

[Basic Concepts]

In each of the following embodiments, a meta information item stretching beyond a scope of a phrase is added to the source sentence, and appropriate translation is done depending on the meta information item at the time of translation. In the embodiments described below, tags added to the source sentence are used as meta information items. Different types of tags are prepared, and different tags are added to the source sentence in accordance with the grammatical type (first embodiment), with the situation or speaker (second embodiment), with the preceding context (third embodiment) or with the target language (fourth embodiment), whereby appropriate translation can be done. In training, it is necessary to train models for translation including a phrase table, by similarly adding same tags during training.

In the first to third embodiments below, an input sentence is subjected to pre-reordering and, thereafter, tags indicating meta information items are added to the head and tail of the input sentence. To pre-reorder means to convert the word order of a source sentence to a word order closer to the word order of the target language. It has been known that pre-reordering improves the accuracy of translation by statistical machine translation (see Watanabe et al., pages 155 to 159). The present invention, however, is not limited to such an embodiment. For example, it is possible to use the meta information items as described above in PBSMT not involving pre-reordering. Further, though the highest effect can be attained when the meta information items are applied to PBSMT, it is believed to be also effective when applied to general statistical translation apparatus other than PBSMT, since meta information items are used for building language models. The fourth embodiment does not use PBSMT but it uses a system performing Sequence-to-Sequence translation using LSTM, one type of the so-called Deep Neural Network (DNN). In the following embodiments, the grammatical type of input sentence, information related to the speaker or the partner, information related to the situation, information related to the context, or information specifying the target language is used as meta information items. The meta information items, however, are not limited to these and any information may be used if it is considered to be useful for translation.

As methods of pre-reordering, Watanabe et al. introduces a method of forming reordering rules manually, a method of training reordering models from a corpus, and a method of automatically training syntactic analysis for reordering itself. In the first to third embodiments described in the following, any of these methods may be used. Further, though pre-reordering is done in any of the first to third embodiments below, it is expected that even when pre-reordering is omitted, the accuracy of translation can be improved compared to translation done without the meta information items.

### First Embodiment

A PBSMT system in accordance with the first embodiment provides an apparatus performing PBSMT, in which different types of tags are used for representing grammatical types of input sentences as meta information items. At the time of training, if a source sentence of a translation pair is a noun phrase, a start tag <NP> is added to a head and an end tag </NP> is added to a tail of a word sequence resulting from pre-reordering, and the PBSMT training is done. If a source sentence of a translation pair is a question, a start tag <SQ> is added to the head and an end tag </SQ> is added to the tail of the word sequence resulting from pre-reordering, and training is done. At the time of translation, tags in accordance with the grammatical type obtained as a result of syntactic analysis are added to the input sentence that has been subjected to pre-reordering in the similar manner as at the time of training, and then, PBSMT is performed.

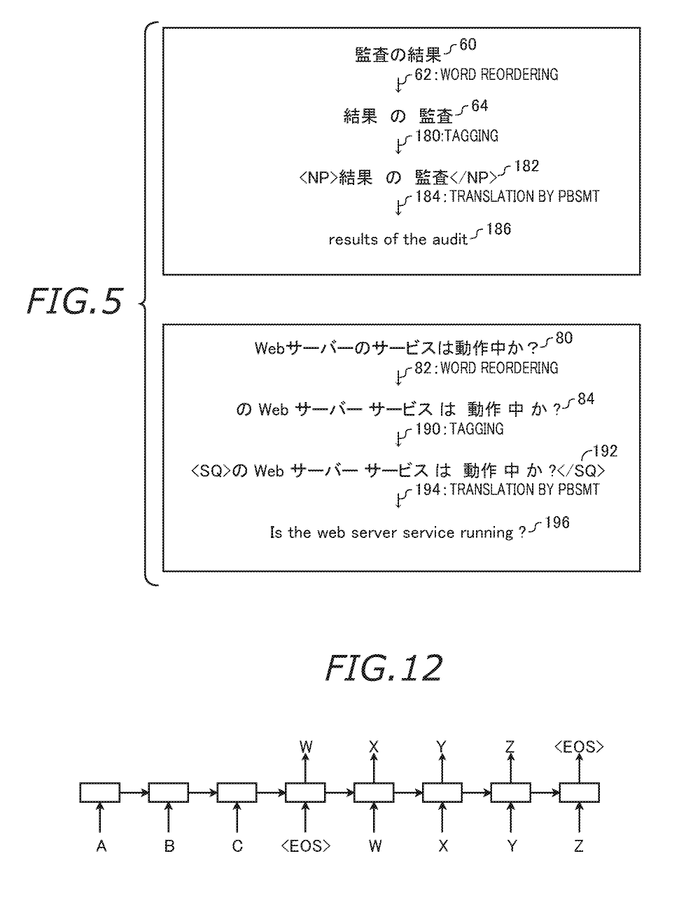

By way of example, referring to the upper part of FIG. 5, assume that an input to translation is a noun phrase 60 of “ [symbol] (kansa no kekka)”. By word reordering 62, a word sequence 64 of “ [symbol] (kekka no kansa)” is obtained. This word sequence 64 is subjected to a tagging process 180 in accordance with grammatical type described above. Here, a tag corresponding to a noun phrase is given as <NP>. Then, a word sequence 182 “<NP> [symbol] </NP> (<NP> kekka no kansa </NP>)” is obtained. When this word sequence 182 is subjected to translation by PBSMT 184, a word sequence 186 of “results of audit” is obtained as a result of translation.

A similar example is shown in the lower part of FIG. 5. Assume that an input is a question sentence 80 of “Web [symbol] [symbol] [symbol] ? (Web server no service wa dousachu ka)”. By word reordering 82 of this question sentence 80, we obtain a word sequence 84. This word sequence is subjected to a tagging 190 in accordance with grammatical type. Here, a tag corresponding to a question sentence is given as <SQ>. As a result, a word sequence 192 having a tag <SQ> at the head and a tag </SQ> at the tail is obtained. When this word sequence 192 is subjected to translation by PBSMT 194, a translated sentence 196 “Is the web server service running?” is obtained.

For pre-reordering, it becomes necessary in a syntax tree to select nodes of which positions are to be changed and to change their positions. For this purpose, if pre-reordering is to be used, syntactic analysis of a source sentence is performed. As a byproduct of the syntactic analysis, a grammatical type of the source sentence is specified. In the following embodiment, this grammatical type is used for determining the tag type.

<Configuration>

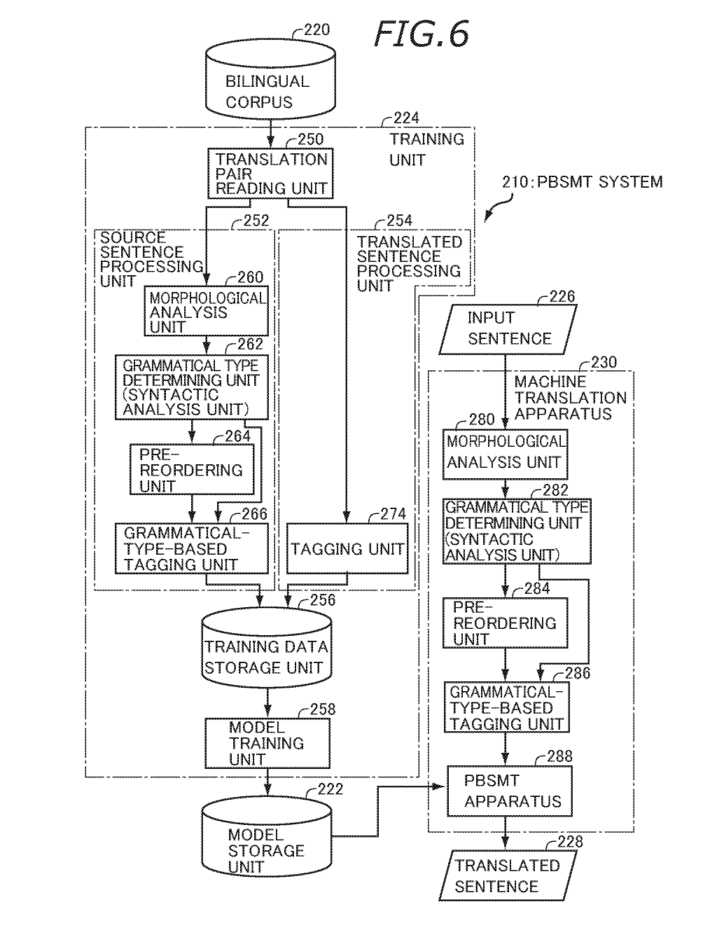

Referring to FIG. 6, a PBSMT system 210 in accordance with the present embodiment includes: a training unit 224 for training statistical models for translation including a phrase table by adding tags in accordance with grammatical types as described above, using translation pair data included in a bilingual corpus 220 as training data, and outputting results to a model storage unit 222; and a machine translation apparatus 230 for, upon reception of an input sentence 226, performing PBSMT on input sentence 226 using models for translation stored in model storage unit 222, and outputting a translated sentence 228.

Training unit 224 using the grammatical type includes: a translation pair reading unit 250 for reading translation pairs included in bilingual corpus 220 and separating each translation pair to a source sentence and a translated sentence; a source sentence processing unit 252 for specifying grammatical type of a source sentence of each translation pair output from translation pair reading unit 250, and tagging the source sentence in accordance with the grammatical type; a translated sentence processing unit 254 for tagging a translation sentence of each translation pair output from translation pair reading unit 250, in a conventional manner; a training data storage unit 256 storing translation pair data each having the source sentence tagged in accordance with the grammatical type output from source sentence processing unit 252 and the translated sentence tagged in the conventional manner output from translated sentence processing unit 254, as model training data; and a model training unit 258 training statistic models for translation using the training data stored in training data storage unit 256 and storing the models in model storage unit 222. While the function itself of model training unit 258 is the same as that of the conventional technique, the models stored in model storage unit 222 are different from the conventional ones since the source sentences are tagged in accordance with the grammatical types.

Source sentence processing unit 252 includes: a morphological analysis unit 260 for morphologically analyzing a source sentence given from translation pair reading unit 250 and outputting a sequence of morphemes; a grammatical type determining unit 262 for performing syntactic analysis and grammatical type determination on the sequence of morphemes output from morphological analysis unit 260 and separately outputting the results of syntactic analysis and the grammatical type; a pre-reordering unit 264 for reordering the word order of word sequence included in the input source sentence to a word order closer to that of a target language by using the result of syntactic analysis output from grammatical type determining unit 262, and outputting the result; and a grammatical-type-based tagging unit 266 for adding, to the head and the tail of word sequence having word order converted by pre-reordering unit 264, start and end tags, respectively, in accordance with the grammatical type received from grammatical type determining unit 262 and outputting a tagged word sequence to training data storage unit 256.

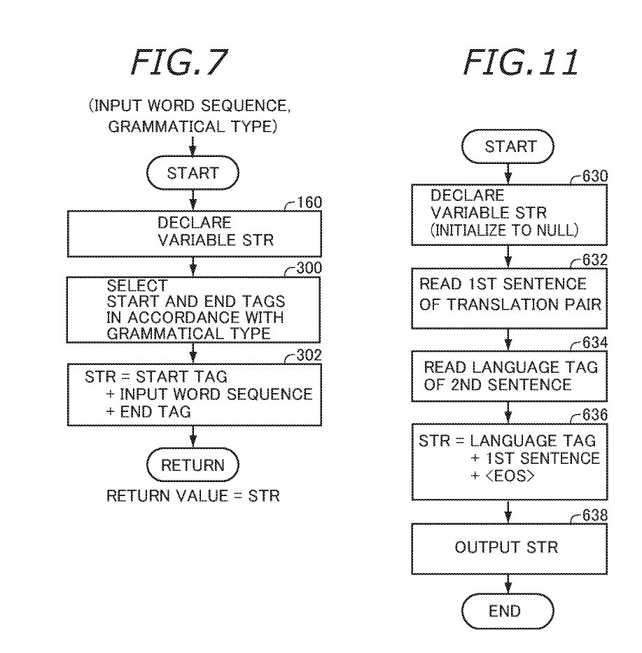

FIG. 7 shows, in the form of a flowchart, an example of a control structure of a computer program realizing grammatical-type-based tagging unit 266 shown in FIG. 6. Referring to FIG. 7, this program is called from a parent routine with arguments consisting of an input word sequence and a grammatical type, and returns a word sequence having a start tag in accordance with the grammatical type added at the head and an end tag in accordance with the grammatical type added at the tail, as a return value. This program includes: a step 160 of declaring a variable STR of a character sequence type used for character sequence operation; a step 300 of selecting a start tag and an end tag in accordance with the grammatical type received as the argument; and a step 302 of storing concatenation of the start tag selected at step 300, the input word sequence received as the argument, and the end tag selected at step 300 into variable STR, and exiting this routine returning the STR.

In order to select the start tag and the end tag in accordance with the grammatical type at step 300, grammatical types and tags may be described in association with each other in this routine, or a look-up table may be stored separately in a memory and the start tag and the end tag may be looked up from the look-up table using the grammatical type as a key.

Translated sentence processing unit 254 is the same as a translated sentence processing unit used in a conventional PBSMT, and it includes a tagging unit 274 configured to receive a translation sentence of each translation pair from translation pair reading unit 250, for adding the conventional start and end tags at the head and tail of word sequence constituting the translated sentence, and outputting the results to training data storage unit 256.

Machine translation apparatus 230 includes: a morphological analysis unit 280 for morphologically analyzing an input sentence 226; a grammatical type determining unit 282 for syntactically analyzing the sequence of morphemes output from morphological analysis unit 280, determining grammatical type of input sentence 226 from the result of syntactic analysis, and outputting the result of syntactic analysis and the grammatical type of input sentence 226; a pre-reordering unit 284 configured to receive the result of syntactic analysis from grammatical type determining unit 282, for outputting a word sequence obtained by reordering words into an order closer to that of the target language prior to translation; a grammatical-type-based tagging unit 286 for receiving the word sequence output from pre-reordering unit 284 and the grammatical type output from grammatical type determining unit 282, adding, to the head and the tail of the word sequence output from pre-reordering unit 284, a start tag in accordance with the grammatical type and an end tag in accordance with the same grammatical type, respectively, and outputting the results; and a PBSMT apparatus 288 configured to receive as an input the tagged word sequence output from grammatical-type-based tagging unit 286, for executing PBSMT and outputting a translated sentence 228.

Grammatical-type-based tagging unit 286 has the same function as grammatical-type-based tagging unit 266 and in the present embodiment, has the same configuration as grammatical-type-based tagging unit 266.

<Operation>

PBSMT system 210 having such a configuration as shown in FIGS. 6 and 7 operates in the following manner. PBSMT system 210 has two main operational phases. The first is a training phase of model storage unit 222, and the second is a test or translation phase of machine translation apparatus 230. In model training, models may be directly trained from training data, or models may be trained from training data and thereafter, weights of features given to the models may be optimized. The present embodiment is effective on both of these methods.

A large number of translation pairs are stored in advance in bilingual corpus 220. It is assumed that the translation pairs prepared here are all phrase-aligned.

Translation pair reading unit 250 reads translation pairs one by one from bilingual corpus 220, applies source sentences to morphological analysis unit 260 of source sentence processing unit 252 and applies translated sentences to tagging unit 274 of translated sentence processing unit 254.

Morphological analysis unit 260 performs morphological analysis of source sentences applied from translation pair reading unit 250 and outputs sequence of morphemes. Grammatical type determining unit 262 performs syntactic analysis of the sequence of morphemes output from morphological analysis unit 260 and simultaneously determines grammatical types, and separately outputs the results of syntactic analysis and the grammatical types. Using the result of syntactic analysis output from grammatical type determining unit 262, pre-reordering unit 264 converts the word order of word sequence included in each input source sentence to a word order closer to that of a target language before translation, and outputs the results. Grammatical-type-based tagging unit 266 adds, to the head and the tail of reordered word sequence output from pre-reordering unit 264, a start tag and an end tag in accordance with the grammatical type received from grammatical type determining unit 262, and outputs the tagged word sequences to training data storage unit 256.

Tagging unit 274 of translated sentence processing unit 254 adds the conventional start and end tags to the head and the tail of word sequence constituting the translated sentence of each translation pair, and outputs the results to training data storage unit 256.

Training data storage unit 256 stores, as a pair, each source sentence tagged with the tags in accordance with the grammatical type, output from grammatical-type-based tagging unit 266, and the corresponding conventionally tagged translated sentences, output from tagging unit 274. Model training unit 258 trains models using the training data stored in training data storage unit 256, and stores their parameters in model storage unit 222.

At the time of translation, machine translation apparatus 230 operates in the following manner.

Model storage unit 222 which stores trained models is connected to machine translation apparatus 230 such that it can be accessed by machine translation apparatus 230. This connection may be realized by storing models in a hard disk of a computer realizing machine translation apparatus 230 and then developing the same on a memory to allow reading of models by a CPU of the computer, or the computer may be connected to model storage unit 222 through a network and the models may be stored in a built-in storage of the computer through the network.

In response to an input sentence 226, morphological analysis unit 280 performs morphological analysis of input sentence 226, and applies the resulting sequence of morphemes to grammatical type determining unit 282. The process of morphological analysis by morphological analysis unit 280 may be triggered by an input of a specific code after the reception of input sentence 226, or it may be triggered by any command input from a user instruction to start translation, separate from the reception of input sentence 226.

Grammatical type determining unit 282 performs syntactic analysis in the similar manner as grammatical type determining unit 262, on the sequence of morphemes output from morphological analysis unit 280, and determines grammatical type of input sentence 226 using the result. Then, it applies the result of syntactic analysis to pre-reordering unit 284 and applies the grammatical type to grammatical-type-based tagging unit 286.

Pre-reordering unit 284 receives the result of syntactic analysis of input sentence 226 applied from grammatical type determining unit 282 and, prior to translation, converts the word order of words constituting input sentence 226 to be closer to the word order of target language. Then, it applies the result to grammatical-type-based tagging unit 286.

Grammatical-type-based tagging unit 286 adds, to the head of reordered word sequence received from pre-reordering unit 284, a start tag in accordance with the grammatical type received from grammatical type determining unit 282, and similarly adds, to the tail of the word sequence, an end tag in accordance with the grammatical type received from grammatical type determining unit 282. Grammatical-type-based tagging unit 286 applies the word sequence having tags added in accordance with the grammatical type in this manner as a source sentence of translation, to PBSMT apparatus 288.

PBSMT apparatus 288 performs PBSMT with the word sequence from grammatical-type-based tagging unit 286 as a source sentence, using the models stored in model storage unit 222, and outputs a translated sentence 228.

### Effects of the Embodiment

In the PBSMT system 210 in accordance with the first embodiment above, different tags are added to the head and tail of each sentence in accordance with the grammatical type. In PBSMT, these tags are handled as words forming a phrase. Therefore, a phrase appearing at the head is distinguishable from the same phrase appearing in the middle of a sentence. Further, a declarative sentence and an interrogative sentence are distinguishable by the tags. Therefore, a phrase pair obtained from a declarative sentence and one from an interrogative sentence will include different tags. Thus, precise phrase table can be obtained and the accuracy of translation is improved. In addition, here, the configuration of PBSMT apparatus itself need not be modified at all. Therefore, the accuracy of machine translation can be improved by a simple configuration.

In the first embodiment described above, syntactic analysis is necessary for pre-reordering, and the grammatical type obtained as a result of syntactic analysis is used for determining tags. The present invention, however, is not limited to such an embodiment. If pre-reordering is not performed, a classifier capable of determining the grammatical type of source sentences may be trained through machine learning, and the classifier may be used.

### Second Embodiment

In the first embodiment described above, different tags are added to source sentences in accordance with grammatical types, as meta information items. For this purpose, in the first embodiment, the grammatical types obtained from the result of syntactic analysis performed on the source sentence at the time of training and at the time of translation are used. The present invention, however, is not limited to such an embodiment. By way of example, tags representing meta information items may be added in advance to source sentences. The second embodiment relates to such a translation system. In this embodiment also, PBSMT is used.

<Configuration>

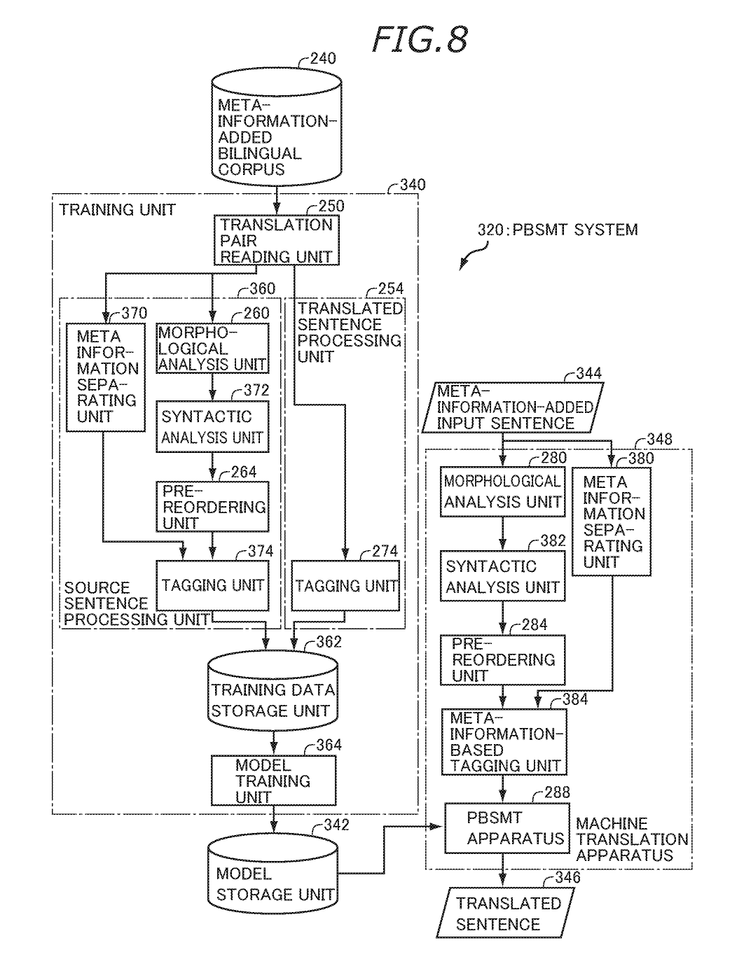

FIG. 8 shows a functional configuration of a PBSMT system 320 in accordance with the second embodiment. Referring to FIG. 8, PBSMT system 320 includes: a training unit 340 using meta information, for training models for PBSMT using meta-information-added bilingual corpus 240 consisting of translation pairs tagged with meta information items, and storing model parameters in a model storage unit 342; and a machine translation apparatus 348 for machine-translating an input sentence 344 with meta information items, using model parameters stored in model storage unit 342 and outputting a translated sentence 346.

Training unit 340 includes: a translation pair reading unit 250; source sentence processing unit 360 configured to receive a source sentence of translation pair from translation pair reading unit 250, for tagging the source sentence in accordance with a meta information item and outputting the result; translated sentence processing unit 254 identical to that of FIG. 6, configured to receive a translated sentence of the translation pair from translation pair reading unit 250, for adding conventional tags to the translated sentence and outputting the result; a training data storage unit 362 for storing, in association with each other, word sequences of source sentences having tags added in accordance with the meta information item, output from source sentence processing unit 360, and translated sentences having conventional tags added, output from translated sentence processing unit 254; and a model training unit 364 for training models for PBSMT using the training data stored in training data storage unit 362 and storing the model parameters in model storage unit 342.

Source sentence processing unit 360 includes: morphological analysis unit 260 identical to that of the first embodiment; a syntactic analysis unit 372 for performing syntactic analysis similar to grammatical type determining unit 262 of the first embodiment; pre-reordering unit 264; meta information separating unit 370 for separating meta information items from the source sentence received from translation pair reading unit 250; and a tagging unit 374 for adding tags corresponding to the meta information items given from meta information separating unit 370, at the head and the tail of a word sequence after pre-reordering received from pre-reordering unit 264, and outputting the result to training data storage unit 362.

Meta information items may be any of: information indicating a speaker, gender, age or profession of the speaker; a partner, gender, age or profession of the partner; and relation between the speaker and the partner. Information indicative of a situation may be, for instance: face-to-face/telephone/TV conference. By adding meta information item or items in advance to each of the translation pairs stored in meta-information-added bilingual corpus 240, statistical model training for the word sequences including meta information becomes possible.

Machine translation apparatus 348 includes: morphological analysis unit 280 configured to receive a word sequence of the meta-information-added input sentence 344 with the meta information item; a syntactic analysis unit 382 for syntactically analyzing a sequence of morphemes output from morphological analysis unit 280; pre-reordering unit 284 using the result of syntactic analysis by syntactic analysis unit 382, for reordering a word sequence forming the input sentence to an order closer to the word order of the target language; a meta information separating unit 380 for separating meta information item from meta-information-added input sentence 344; a meta-information-based tagging unit 384 for adding tags to the head and the tail of pre-reordered word sequence applied from pre-reordering unit 284, in accordance with meta information item output from meta information separating unit 380 and outputting the result; and a PBSMT apparatus 288 configured to receive, as an input, the word sequence with meta-information-based tags, output from meta-information-based tagging unit 384, for performing PBSMT using models for machine translation based on the model parameters stored in model storage unit 342, and outputting a translated sentence 346.

<Operation>

In the first embodiment shown in FIG. 6, at the time of training, tags in accordance with grammatical types are added to word sequences using grammatical types determined by grammatical type determining unit 262. In the second embodiment, different from the first embodiment, at the time of training, meta information separating unit 370 separates beforehand the meta information item from the meta-information-added translation pairs, and tagging unit 374 adds tags that differ in accordance with the meta information items to the word sequences. What is to be used as a meta information item is determined in advance, and the meta information item is added to the translation pairs for training. Thus, model training for machine translation can be done efficiently using the meta information item.

Similarly, at the time of translation, an input sentence 344 has a meta information item added thereto. Meta information separating unit 380 separates the meta information item, and applies it to meta-information-based tagging unit 384. Meta-information-based tagging unit 384 adds tags that differ in accordance with the meta information items to the word sequence of source sentence, and inputs the result to PBSMT apparatus 288. By adding the meta information item of the type used during training to input sentence 344, it becomes possible to obtain an appropriately translated sentence 346 in accordance with the meta information item.

As in the case of grammatical type obtained as a result of syntactic analysis, if the meta information item obtained by analyzing the source sentence is used, it is unnecessary to add meta information item to the translation pairs in the bilingual corpus 220 at the time of training and to the input sentence 344 at the time of translation.

### Third Embodiment

In the first embodiment, tags are selected in accordance with the grammatical type information determined based on the result of syntactic analysis of the source sentence. In the second embodiment, tags are selected in accordance with meta information added in advance to a source sentence or obtained by analyzing a source sentence. In the third embodiment described in the following, grammatical type of an immediately preceding sentence is stored as context information corresponding to the meta information, and tags that differ depending on the context information are added to the source sentence. By such a scheme, it becomes possible to translate a source sentence differently in accordance with the contexts.

<Configuration>

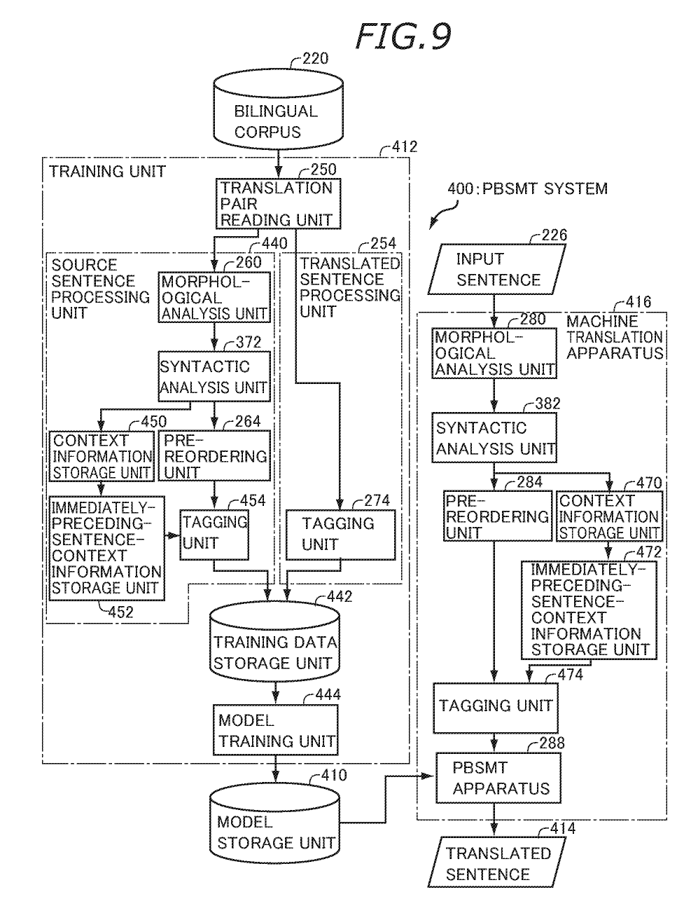

Referring to FIG. 9, a PBSMT system 400 in accordance with the third embodiment includes: a training unit 412 for training the models for machine translation using translation pairs in bilingual corpus 220, and storing model parameters and the like in a model storage unit 410; and a machine translation apparatus 416 for performing PBSMT on input sentence 226 using models for translation constituted, for example, by model parameters stored in model storage unit 410, and outputting a translated sentence 414.

Training unit 412 includes: translation pair reading unit 250 identical to that of FIG. 6; a source sentence processing unit 440 configured to receive a source sentence of the translation pair from translation pair reading unit 250, for adding to the head and the tail of each source sentence different start and end tags in accordance with the context of the sentence, respectively, and outputting the result; translated sentence processing unit 254 identical to that of FIG. 6, for adding tags to the translated sentence of translation pair applied from translation pair reading unit 250 and outputting the result; a training data storage unit 442, for storing training data including word sequences of source sentences having tags added thereto output from source sentence processing unit 440 and the translated sentences having conventional tags output from translated sentence processing unit 254 aligned with each other; and a model training unit 444 for training models for PBSMT using the training data stored in training data storage unit 442 and storing model parameters and the like in model storage unit 410.

Source sentence processing unit 440 includes: morphological analysis unit 260; syntactic analysis unit 372; pre-reordering unit 264; a context information storage unit 450 for storing an information item as context information indicating whether the source sentence being processed is a negative question or not, based on the result of syntactic analysis by syntactic analysis unit 372; an immediately-preceding-sentence-context information storage unit 452 for shifting and storing a context information item stored in context information storage unit 450 after processing one sentence and outputting the information item as context information obtained from an immediately preceding source sentence; and a tagging unit 454 for adding, to a pre-reordered word sequence of a source sentence output from pre-reordering unit 264, with tags that differ in accordance with the context of one preceding sentence stored in immediately-preceding-sentence-context information storage unit 452 and outputting the result to training data storage unit 442.

Machine translation apparatus 416 includes morphological analysis unit 280, syntactic analysis unit 382, and pre-reordering unit 284 shown in FIG. 8 and, in addition, it includes: a context information storage unit 470 for storing context information indicating whether an input sentence 226 is a negative question or not, obtained from the output of syntactic analysis unit 382; an immediately-preceding-sentence-context information storage unit 472 for shifting, storing and outputting context information stored in context information storage unit 470 as context information of an immediately preceding sentence every time machine translation apparatus 416 processes one sentence; a tagging unit 474 for adding, to the head and the tail of input sentence 226 pre-reordered by pre-reordering unit 284, tags that differ in accordance with the immediately-preceding-sentence-context information stored in immediately-preceding-sentence-context information storage unit 472, and outputting the result; and a PBSMT apparatus 288 configured to receive as an input a tagged word sequence output from tagging unit 474, for performing PBSMT with reference to translation model parameters and the like stored in model storage unit 410 and outputting a translated sentence 414.

<Operation>

PBSMT system 400 operates as follows.

At the time of model training, translation pair reading unit 250 takes out translation pairs one by one from bilingual corpus 220, and applies source sentences to morphological analysis unit 260 of source sentence processing unit 440 and translated sentences to tagging unit 274 of translated sentence processing unit 254, respectively. In the present embodiment, different tags are added to the source sentences in accordance with the contexts. Therefore, the translation pairs stored in bilingual corpus 220 are ordered and translation pair reading unit 250 must read the translation pairs in order from bilingual corpus 220.

Morphological analysis unit 260 and syntactic analysis unit 372 perform morphological analysis and syntactic analysis, respectively, on the source sentence, and the result of syntactic analysis is applied to pre-reordering unit 264. Syntactic analysis unit 372 outputs, from the result of syntactic analysis, context information indicating whether the sentence is a negative question or not. Context information storage unit 450 stores this context information. Pre-reordering unit 264 performs pre-reordering on the word sequence of source sentence using the result of syntactic analysis by syntactic analysis unit 372, and applies the reordered word sequence to tagging unit 454. Tagging unit 454 adds, to the head and the tail of the word sequence output from pre-reordering unit 264, a start tag and an end tag, which differ depending on the context information of immediately-preceding sentence stored in immediately-preceding-sentence-context information storage unit 452, and applies the result to training data storage unit 442. When a first sentence is processed, nothing is stored in immediately-preceding-sentence-context information storage unit 452 and, therefore, immediately preceding sentence is assumed to be a declarative sentence.

When such a process is to be done, if sentences extracted from different documents are to be processed continuously, it is undesirable to use the context information obtained from the last sentence of the preceding document as the context information of the first sentence of the next document. Therefore, the context information stored in immediately-preceding-sentence-context information storage unit 452 should be cleared every time the documents are changed.

Translated sentence processing unit 254 adds conventional tags to the translated sentences of translation pairs. Training data storage unit 442 stores the word sequences of pre-reordered source sentences each having the context information of immediately preceding sentence output from tagging unit 454 and the word sequences of translated sentences output from tagging unit 274, associated with each other.

When the training data becomes available in training data storage unit 442, model training unit 444 starts training of translation models using the training data. The model parameters and the like of the trained models are stored in model storage unit 410.

When the input sentence 226 is translated, machine translation apparatus 416 operates in the following manner. Since the context information is also used at the time of translation, the input sentence 226 applied to machine translation apparatus 416 must be given to machine translation apparatus 416 in accordance with the order of appearance of the sentence in the document.

When input sentence 226 is applied, morphological analysis unit 280 performs morphological analysis, and applies the resulting sequence of morphemes to syntactic analysis unit 382. Syntactic analysis unit 382 performs syntactic analysis of the sequence of morphemes, and applies the result of syntactic analysis to pre-reordering unit 284. The result of syntactic analysis includes information indicating whether the sentence is a negative question or not. Context information storage unit 470 stores this information. Pre-reordering unit 284 converts the word order of word sequence constituting input sentence 226 to be closer to the word order of target language prior to translation, using the result of syntactic analysis applied from syntactic analysis unit 382, and applies the re-ordered result to tagging unit 474. Tagging unit 474 reads the context information of an immediately preceding sentence stored in immediately-preceding-sentence-context information storage unit 472 and adds, to the head and the tail of the input word sequence a start tag and an end tag, which differ in accordance with the context information, and outputs the result.

PBSMT apparatus 288 performs PBSMT on the tagged word sequence output from tagging unit 474 by applying translation models consisting of model parameters and the like stored in model storage unit 410, and outputs a translated sentence 414. When output of translated sentence 414 is completed, context information stored in context information storage unit 470 is shifted to immediately-preceding-sentence-context information storage unit 472, and becomes available as context information of an immediately preceding sentence.

### Effects of the Embodiment

According to the present embodiment, in the translation phase, context information indicating whether or not the immediately preceding source sentence is a negative question is stored in immediately-preceding-sentence-context information storage unit 472. By adding tags in accordance with the context information to the word sequence and using the same as an input to PBSMT apparatus 288, it becomes possible to appropriately translate the sentence in accordance with the context as to whether the immediately preceding sentence is a negative question or not.

In the third embodiment, whether or not the immediately preceding sentence is a negative question is used only as the context information. The present invention, however, is not limited to such an embodiment. A series of sentences preceding a sentence may be collected and classified, and tags may be added to the succeeding sentence in accordance with the class. Classes may be positive/negative, interrogative/declarative, or any combination thereof.

In the embodiments described above, PBSMT is used as machine translation engines. The present invention, however, is not limited to such embodiments. The same effects as described in the embodiments above can be attained even when other machine translation scheme is used, provided that it uses a model trained by statistical processing of translation pairs.

In the first to third embodiments above, tags indicating meta information items are added to the head and the tail of each source sentence. The present invention, however, is not limited to such embodiments in which meta information items are added to such positions. In short, what is necessary is to add tags at portions that specify portions to be translated differently. In that case, the portion that should be translated differently is regarded as the source sentence. The fourth embodiment below describes such an example.

### Fourth Embodiment

<Configuration>

As will be described in the fourth embodiment below, when a tag is added and a next tag is encountered, it is determined that the scope of influence of meta information item represented by the preceding tag has reached to an end. In such a case, an end tag of the meta information item can be omitted. Further, when the tail of a sentence as an object of translation is reached, it is considered to be the end of the scope of influence of meta information item represented by the preceding tag. In this case also, an end tag can be omitted.

In the first embodiment, tags are selected in accordance with the grammatical type information determined from the result of syntactic analysis of the source sentence. In the second embodiment, tags are selected in accordance with meta information items added in advance to the source sentence or meta information items obtained by analysis of the source sentence. In the third embodiment, as the information corresponding to the meta information item, grammatical type of the immediately preceding sentence is stored as context information, and different tags are added to the source sentence in accordance with the context information. In the fourth embodiment described in the following, a tag specifying the target language is added at the head of source sentence, as meta information item. At the time of model training, a meta information item specifying the other language of translation pair is added to one of the translation pair, and training is done. At the time of translation, a meta information item specifying the target language is added to the head of input sentence. In this manner, translation into different languages becomes possible using one model.

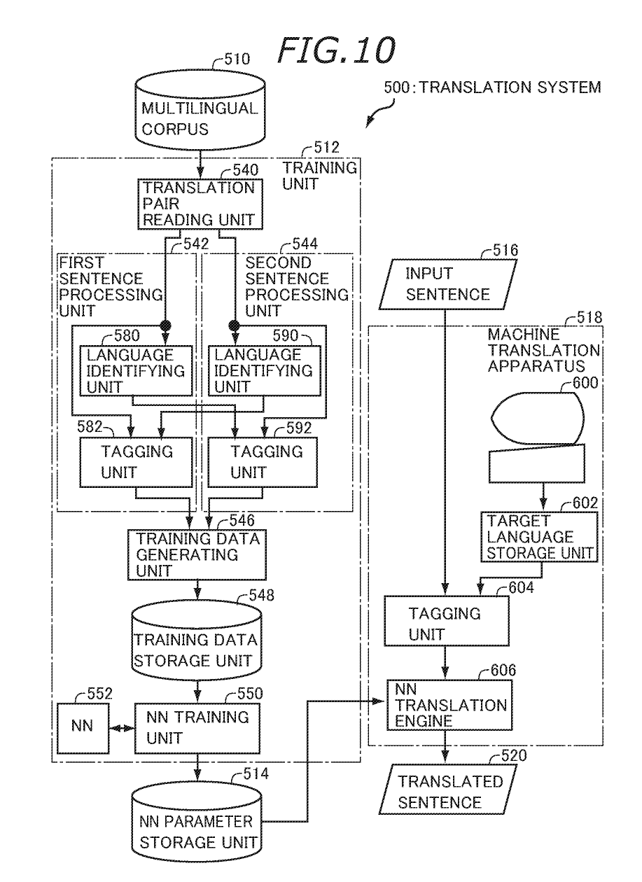

Referring to FIG. 10, a translation system 500 in accordance with the present embodiment includes: a multilingual corpus 510 including translation pairs related to combinations of multiple languages; a training unit 512 for reading each translation pair from multilingual corpus 510 and training NN for performing Sequence-to-Sequence type translation; and an NN parameter storage unit 514 for storing parameters of NN trained by training unit 512. In the present embodiment, it is assumed that each translation pair in multilingual corpus 510 does not have any information representing its language. The NN used in the present embodiment has the same configuration as the one using LSTM described in Sutskever et al.

Training unit 512 includes: a translation pair reading unit 540 for reading each translation pair from multilingual corpus 510; a first sentence processing unit 542 for adding, to the head of a first sentence, a tag specifying language of a second sentence, of the translation pair read by translation pair reading unit 540 and outputting the result; a second sentence processing unit 544 for adding, to the head of the second sentence, a tag specifying the language of the first sentence, of the translation pair read by translation pair reading unit 540, and outputting the result; a training data generating unit 546 for generating and outputting training data by paring the first sentence output from the first sentence processing unit 542 and the second sentence output from the second sentence processing unit 544; a training data storage unit 548 for storing the output training data; and an NN training unit 550 for training NN 552 using each translation pair data stored in training data storage unit 548.

In the present embodiment, each of the translation pairs stored in multilingual corpus 510 is a pair of a sentence in one language and a sentence in another language. The present invention, however, is not limited to such an embodiment. By way of example, a corpus containing groups of translations each including mutual translations of three or more languages may be used. In that case, for example, translation pair reading unit 540 may select any two sentences from each translation group as parallel translations and to give them to the first sentence processing unit 542 and the second sentence processing unit 544. Therefore, the tags used in the present embodiment are at least two, and the number of tags is the same as the number of languages of parallel translations stored in multilingual corpus 510.

The first sentence processing unit 542 includes a language identifying unit 580 for identifying the language of the first sentence of translation pair read by translation pair reading unit 540. Likewise, the second sentence processing unit 544 includes a language identifying unit 590 for identifying the language of the second sentence and outputting information item specifying the language. First sentence processing unit 542 further includes a tagging unit 582 for tagging the first sentence of the translation pair read by translation pair reading unit 540, with a tag indicating the language of the second sentence output from language identifying unit 590 and outputting the result. Likewise, the second sentence processing unit 544 further includes a tagging unit 592 for tagging the second sentence of the translation pair read by translation pair reading unit 540, with a tag indicating the language of the first sentence output from language identifying unit 580 and outputting the result.

Tagging units 582 and 592 shown in FIG. 10 have the same configurations and, in the present embodiment, both are realized by a computer program. Referring to FIG. 11, by way of example, a program realizing tagging unit 582 includes: a step 630 of declaring a variable STR; a step 632 of reading the first sentence of the translation pair to be processed from a memory location storing an output of translation pair reading unit 540, a step 634 of reading, from a memory location storing an output of language identifying unit 590, a language tag indicating the language of the second sentence; a step 636 of assigning a sequence of characters obtained by concatenating the language tag read at step 634, the first sentence read at step 632 and a symbol <EOS> indicating end of sentence, to the variable STR; and a step 638 of outputting the contents stored in variable STR to training data generating unit 546.

In the program realizing tagging unit 592, the first sentence in FIG. 11 should be read as the second sentence, and the second sentence should be read as the first sentence.

Referring to FIG. 10, training data generating unit 546 generates training data from the outputs of first sentence processing unit 542 and the outputs of the second sentence processing unit 544. Specifically, training data generating unit 546 generates training data having the outputs of the first sentence processing unit 542 as source sentences and the outputs of the second sentence processing unit 544 as translated sentences, and training data having the outputs of the second sentence processing unit 544 as source sentences and the outputs of the first sentence processing unit 542 as translated sentences, and stores them in training data storage unit 548. By training data generating unit 546, it is possible to prepare bi-directional training data with regard to the combination of languages of the first and second sentences.

NN training unit 550 has a function of training NN 552 using the training data stored in training data storage unit 548. This training can be done in the similar manner as the technique discussed in Sutskever et al.

The training described in Sutskever et al. can be summarized as follows. Assume that a source sentence of translation pair for training includes words A, B and C, and the translated sentence includes words X, Y and Z. A symbol of end of sentence <EOS> is added to each of these. Referring to FIG. 12, first, words A, B and C of the input sentence are applied in order as inputs to NN, and NN is trained using these as teacher signals, by back propagation algorithm. As to the symbol <EOS> indicating the end of input sentence, the head word W in translated sentence is used as a teacher signal and NN is trained. Then, words X, Y and Z of translated sentence are used as inputs and following words Y, Z and the symbol <EOS> indicating the end of translated sentence are used as teacher signals, and NN is trained. Such a process is performed on every translation pair.

The training of NN 552 performed by NN training unit 550 in the present embodiment is the same except that a tag indicating the language of the counterpart of parallel translation is added to the head of each input sentence.

Returning to FIG. 10, machine translation apparatus 518 using NN is to perform machine translation using NN on an input sentence 516 and to output a translated sentence 520. Machine translation apparatus 518 includes: an input/output device 600 configured to receive, in an interactive manner, a user input for determining a target language of translation; a target language storage unit 602 for storing a tag indicating the target language input by input/output device 600; a tagging unit 604 connected to target language storage unit 602, configured to receive input sentence 516, for adding the tag read from target language storage unit 602 to the head and the end symbol <EOS> to the tail thereof and outputting the result; and an NN translation engine 606 for performing translation by NN having the same configuration as NN 552, having parameters stored in NN parameter storage unit 514, on the tagged input sentence 516 output from tagging unit 604, and outputting a translated sentence 520.

Though the present embodiment assumes that the target language of translation is designated by a user using input/output device 600, the present invention is not limited to such an embodiment. By way of example, a language selected as a user interface language of a device (smartphone, computer or the like) in which machine translation apparatus 518 is incorporated, may be used.

<Operation>

The translation system 500 having the above-described configuration operates in the following manner. There are two phases in operation of translation system 500. The first is an NN training phase, and the second is a translation phase by machine translation apparatus 518.

At the time of training, training unit 512 of translation system 500 operates as follows. In multilingual corpus 510, many parallel translations related to combinations of a number of languages are stored in advance. Translation pair reading unit 540 takes out translation pairs in order from multilingual corpus 510, applies the first sentence of each translation pair to the first sentence processing unit 542 and applies the second sentence to the second sentence processing unit 544. Language identifying unit 580 of first sentence processing unit 542 identifies the language of the first sentence, and stores a tag indicating that language in a prescribed memory location. Language identifying unit 590 of the second sentence processing unit 544 similarly identifies the language of the second sentence, and stores a tag indicating that language in a prescribed memory location. Receiving the first sentence of the translation pair from translation pair reading unit 540, tagging unit 582 reads from the prescribed memory location the tag of the language identified by language identifying unit 590, adds the tag to the head and adds the symbol of end of sentence <EOS> to the tail of the first sentence, and outputs the result to training data generating unit 546. Similarly, tagging unit 592 receives the second sentence of translation pair from translation pair reading unit 540, reads from the prescribed memory location the tag indicating the language of the first sentence, adds the tag at the head and adds the symbol of end of sentence <EOS> to the tail of the second sentence, and outputs the result to training data generating unit 546.

Training data generating unit 546 generates training data having the first sentence received from tagging unit 582 as source sentence and the second sentence received from tagging unit 592 as the translated sentence, and training data having the second sentence received from tagging unit 592 as the source sentence and the first sentence received from tagging unit 582 as the translated sentence, and stores these in training data storage unit 548. In this manner, translation pair reading unit 540, the first sentence processing unit 542, the second sentence processing unit 544 and training data generating unit 546 generate a large number of training data and store them in training data storage unit 548.

When a sufficient amount of training data is generated in training data storage unit 548, NN training unit 550 performs training of NN 552 using the training data. The manner of training is as described above. When the parameters of NN 552 satisfy an end condition during training, training of NN 552 ends and parameters defining the function of NN 552 at that time are stored in NN parameter storage unit 514. Thus, training of NN is completed. The parameters are set in NN included in translation engine 606.

At the time of translation, machine translation apparatus 518 operates in the following manner. Prior to translation, a user designates a target language of translation using input/output device 600. Target language storage unit 602 saves a tag indicating the designated language.

When input sentence 516 is input to machine translation apparatus 518 and translation is requested, tagging unit 604 reads the tag indicating the target language from target language storage unit 602, and adds the tag at the head of input sentence 516. Further, tagging unit 604 adds the end of sentence symbol <EOS> to the tail of input sentence 516 and inputs this to translation engine 606.

Translation engine 606 applies each word of input sentence 516 one by one as input to the NN having parameters set by training. When the end of sentence symbol <EOS> at the tail of input sentence 516 is applied as an input, the word obtained at the output of NN becomes the head word of translation. Thereafter, the word obtained in this manner is applied to the input of NN, and the resulting output is successively connected, and thus, word sequence of translation for the input sentence 516 is obtained. When the end of sentence symbol <EOS> is obtained as the output of NN, translation by translation engine 606 ends, and the word sequence obtained by that time are concatenated and output as translated sentence 520.

### Effects of the Embodiment

In translation system 500 in accordance with the fourth embodiment described above, different tag is added to the head of each sentence for different target language of translation. In NN, these tags are also considered as input words to NN as the translation engine. Therefore, by the NN trained by parallel translations of a plurality of languages using such tags, translations among a plurality of languages are possible by one NN. Assume that a plurality of languages have common characteristics and the number of translation pairs including sentences of a certain one of these languages is small. Even in such a situation, by training using parallel translations of languages having common characteristics other than the certain language, it is expected that the accuracy of translation of the certain language is also improved. Further, in that case, the configuration of translation engine realized by NN itself need not be changed at all, and what is necessary is simply to add the tag indicating the target language of translation to the head of each sentence. Thus, the accuracy of machine translation can be improved by a simple configuration.

In the fourth embodiment described above, languages are identified by language identifying unit for both the first and second sentences of the parallel translations at the time of training. If information specifying the languages is added to each of the parallel translations stored in multilingual corpus 510, it is unnecessary to provide the language identifying unit, and a tag indicating the target language of translation may be identified using the added information. Another option is to introduce a preprocessing of adding a tag indicating the language of counterpart sentence to the head of each of the parallel translations in multilingual corpus 510.

In the embodiment described above, an LSTM based NN is used as the translation engine. The present invention, however, is not limited to such an embodiment. Even when an RNN using cells other than LSTM is adopted, similar effects as the fourth embodiment are expected, since what is necessary is the same training.

[Computer Implementation]

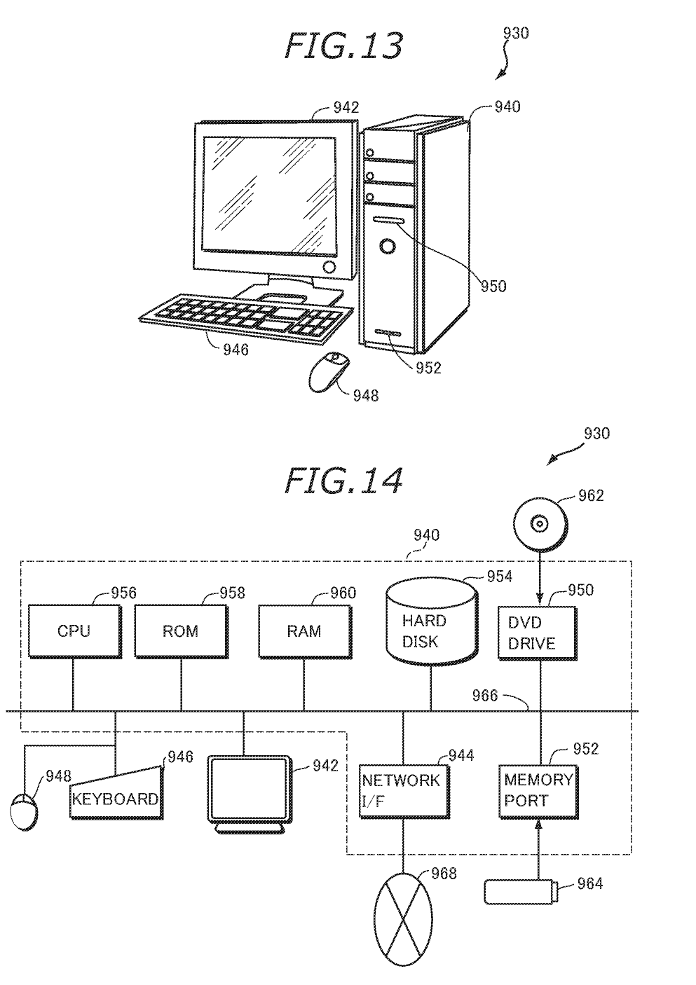

The machine translation system, the training unit and the machine translation apparatus in accordance with the embodiments above can be implemented by computer hardware and computer programs executed on the computer hardware. FIG. 13 shows an appearance of computer system 930 and FIG. 14 shows an internal configuration of computer system 930.

Referring to FIG. 13, computer system 930 includes a computer 940 having a memory port 952 and a DVD (Digital Versatile Disk) drive 950, a keyboard 946, a mouse 948, and a monitor 942.

Referring to FIG. 14, computer 940 includes, in addition to memory port 952 and DVD drive 950, a CPU (Central Processing Unit) 956, a bus 966 connected to CPU 956, memory port 952 and DVD drive 950, a read-only memory (ROM) 958 storing a boot-up program and the like, and a random access memory (RAM) 960 connected to bus 966, storing program instructions, a system program and work data. Computer system 930 further includes a network interface (I/F) 944 providing the computer 940 with the connection to a network allowing communication with another terminal. Network I/F 944 may be connected to the Internet 968.

The computer program causing computer system 930 to function as the machine translation system, training unit or the machine translation apparatus in accordance with each of the embodiments above is stored in a DVD 962 or a removable memory 964 loaded to DVD drive 950 or to memory port 952, and transferred to hard disk 954. Alternatively, the program may be transmitted to computer 940 through network I/F 944, and stored in hard disk 954. At the time of execution, the program is loaded to RAM 960. The program may be directly loaded from DVD 962, removable memory 964 or through network I/F 944 to RAM 960.

The program includes instructions to cause computer 940 to operate as functioning sections of the machine translation system, training unit or the machine translation apparatus in accordance with each of the embodiments above. Some of the basic functions necessary to realize the operation are provided by the operating system (OS) running on computer 940, by third party programs, or by modules of various programming tool kits installed in computer 940. Therefore, the program may not necessarily include all of the functions necessary to realize the machine translation system, training unit or the machine translation apparatus of the present embodiment. The program has only to include instructions to realize the functions of the above-described the machine translation system, training unit or the machine translation apparatus by calling appropriate functions or appropriate program tools in a program tool kit in a manner controlled to attain desired results. The operation of computer system 930 is well known and, therefore, description thereof will not be repeated here.

It is noted that various corpora are finally stored in hard disk 954 and appropriately developed on RAM 960 in the embodiments above. The model parameters and the like for translation are all stored in RAM 960. The model parameters and the like eventually optimized are stored from RAM 960 to hard disk 954, DVD 962 or removable memory 964. Alternatively, the model parameters may be transmitted to another apparatus through network IT 944, or they may be received from another apparatus.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A machine translation apparatus implemented by a computer including a storage device and a central processing unit, wherein
by a program stored in said storage device, said central processing unit is programmed or configured
to specify a meta information item related to translation,
to insert a tag corresponding to said meta information item to a prescribed position of a source sentence of translation, and
to receive said source sentence with said tag as an input, and to execute machine translation;
a predetermined plurality of types of items are defined as said meta information item; and
said central processing unit is programmed or configured to select said tag in accordance with the type of said meta information item.

2. The machine translation apparatus according to claim 1, wherein said central processing unit is programmed or configured to insert first and second tags corresponding to said meta information item to head and tail positions, respectively, of a scope of said source sentence to be translated in order to identify said scope using said meta information item, when a tag related to said meta information item is to be inserted to said source sentence.

3. The machine translation apparatus according to claim 1, wherein said central processing unit is programmed or configured, when said meta information item is to be identified,
to perform morphological analysis of said source sentence,
to perform syntactic analysis of said morphologically-analyzed source sentence, and
to output information indicating grammatical type of said source sentence obtained as a result of syntactic analysis of the source sentence, as said meta information item of said source sentence.

4. The machine translation apparatus according to claim 1, wherein
said source sentence is tagged with said meta information item related to translation of said source sentence; and
said central processing unit is programmed or configured to separate said meta information item added to said source sentence from said source sentence, when said meta information item is to be identified.

5. The machine translation apparatus according to claim 1, wherein said meta information item is selected from the group consisting of grammatical type of said source sentence, situation information related to a situation where said source sentence is uttered, speaker information related to a speaker who utters said source sentence, and a grammatical type of a preceding source sentence subjected to said machine translation prior to said source sentence.

6. The machine translation apparatus according to claim 1, wherein said central processing unit is programmed or configured to perform phrase-based statistical machine translation, when said machine translation is to be executed.

7. The machine translation apparatus according to claim 1, wherein said central processing unit is programmed or configured, when said meta information item is to be identified,
to identify target language of said translation as said meta information item, and
when a tag corresponding to said meta information item is to be inserted to said source sentence, to insert a tag indicating said translation target language identified by said meta information item to a prescribed position of said source sentence.

8. The machine translation apparatus according to claim 7, wherein said central processing unit is programmed or configured to perform neural-network-based machine translation, when said machine translation is to be executed.

9. The machine translation apparatus according to claim 1, wherein said central processing unit is programmed or configured to perform neural-network-based machine translation, when said machine translation is to be executed.

10. A machine translation method implemented by a computer including a storage device and a central processing unit, comprising the steps of:
identifying a meta information item related to translation;
inserting a tag corresponding to said meta information item to a prescribed position of a source sentence of translation; and
receiving said source sentence with said tag as an input and executing machine translation; wherein
a predetermined plurality of types of items are defined as said meta information items; and
said step of identifying said meta information item includes the step of selecting said tag in accordance with the type of said meta information item.

11. The machine translation method according to claim 10, wherein said step of inserting a tag corresponding to said meta information item includes, in order to identify a scope of said source sentence to be translated using said meta information item, the step of inserting first and second tags corresponding to said meta information item to head and tail positions, respectively, of said scope.

12. The machine translation method according to claim 10, wherein said step of identifying said meta information item includes the steps of;
morphologically analyzing said source sentence,
syntactically analyzing said morphological-analyzed source sentence, and
outputting information indicating grammatical type of said source sentence obtained as a result of syntactic analysis of the source sentence, as said meta information item of said source sentence.

13. The machine translation method according to claim 10, wherein
said source sentence has said meta information item related to translation of said source sentence added; and
said step of identifying said meta information item includes the step of separating said meta information item added to said source sentence from said source sentence.

14. The machine translation method according to claim 10, wherein said meta information item is selected from the group consisting of grammatical type of said source sentence, situation information related to a situation where said source sentence is uttered, speaker information related to a speaker who utters said source sentence, and a grammatical type of a preceding source sentence subjected to said machine translation prior to said source sentence.

15. The machine translation method according to claim 10, wherein said step of executing machine translation includes the step of receiving said source sentence with said tag as an input and performing phrase-based statistical machine translation on said input.

16. The machine translation method according to claim 10, wherein said step of identifying said meta information item includes the step of identifying target language of said translation as said meta information item, and
said step of inserting a tag corresponding to said meta information item includes the step of inserting a tag indicating said translation target language identified by said meta information item to a prescribed position of said source sentence.

17. The machine translation method according to claim 16, wherein said step of executing machine translation includes the step of performing neural-network-based machine translation.

18. The machine translation method according to claim 10, wherein said step of executing machine translation includes the step of performing neural-network-based machine translation.

19. A non-transitory storage medium having stored thereon a computer program causing a computer to execute each of the steps in claim 10.
